(19) United States
(12) Patent Application Publication
(10) Pub. No.: US 2016/0330968 A1
(43) Pub. Date: Nov. 17, 2016

(54) SANITIZING PRODUCT CREATION SYSTEM

(71) Applicants: David Owens, Westford, MA (US); Pat Lucci, Westford, MA (US); Michael Marcinkowski, Westford, MA (US); Sandy Posa, Westford, MA (US); John Gentile, Montclair, NJ (US); Ronald H. Haag, Lake Orion, MI (US); Mike Brody, New York, NY (US); Tayler Kaiserman, Brooklyn, NY (US); Terrance Z. Kaiserman, Loxahatchee, FL (US); Steven Martin Cohen, New York, NY (US)

(72) Inventors: David Owens, Westford, MA (US); Pat Lucci, Westford, MA (US); Michael Marcinkowski, Westford, MA (US); Sandy Posa, Westford, MA (US); John Gentile, Montclair, NJ (US); Ronald H. Haag, Lake Orion, MI (US); Mike Brody, New York, NY (US); Tayler Kaiserman, Brooklyn, NY (US); Terrance Z. Kaiserman, Loxahatchee, FL (US); Steven Martin Cohen, New York, NY (US)

(21) Appl. No.: 15/013,429

(22) Filed: Feb. 2, 2016

Related U.S. Application Data
(60) Provisional application No. 62/110,889, filed on Feb. 2, 2015.

(51) Int. Cl. A01N 59/00; C01D 1/04; C01B 11/04

(52) U.S. Cl. CPC A01N 59/00; C01B 11/04; C01D 1/04

(57) ABSTRACT

A sanitizing product creation system employing electricity to produce products useful for sanitizing and disinfecting surfaces.

### RELATED APPLICATIONS

This application claims priority to U.S. Provisional Application No. 62/110,889, filed Feb. 2, 2015 which is incorporated herein by reference in its entirety.

### FIELD OF INVENTION

Sanitizing products, more specifically, sanitizing products involving the creation of a sanitizing product using reactants and electricity.

### BACKGROUND OF INVENTION

The use of electricity and electrolyzing cells to produce hypochlorous acid, sodium hypochlorite, and sodium hydroxide is not new. Many of these systems rely on the use of semi-permeable membranes to mechanically isolate the anode and cathode of an electrolyzing cell while permitting ion transfer between anode and cathode to complete the electrical circuit. Chloride ions are oxidized at the anode to form chlorine, when then combine with water to make hypochlorous acid. This is drawn off the anode cell. Water is reduced at the cathode into hydrogen gas and hydroxide ions. The hydroxide ions combine with sodium ions to make sodium hydroxide, and this is drawn off the cathode cell. Replenishing water can enter both cells. Many systems are made to continuously operate, thus requiring a balance between charge delivered and liquid removed in a continuous flow system. Industrial size systems are used in large venues.

The invention fills a gap in the market and targets home use as well as affording the portability necessary in larger venues. The present invention teaches the ability to create small batches of cleaning and/or sanitizing solutions in the same portable dispensing container in which the products are created, thus eliminating the need to produce the desired products in one volumetric system and subsequently transfer desired products into another vessel in which the products can then be applied to surfaces.

### SUMMARY OF INVENTION

The present invention enables hypochlorous acid and/or sodium hydroxide to be produced in a spray bottle or containment vessel using electricity passing between an anode and a cathode. The bottle can then be removed from a base unit that contains a cradle and power supply, and the vessel then functions as a spray bottle from which to dispense the prepared cleaning solution. This type of system enables production of cleaning and sanitizing products as needed, thus insuring full concentration of the cleaning and sanitizing agents.

One embodiment of the present invention is a product production system comprising a base unit comprising of a source of power, a control circuit and/or electronics, a means of connecting the source of power to at least two electrical contacts, a cradle, and a removable attachable containment vessel comprising of at least one liquid that can be added and/or removed, at least one anode electrode, at least one cathode electrode, a means of connecting at least two mating electrical contacts to at least one anode electrode and at least one cathode electrode, and at least one means to cause the transport of at least one liquid from the containment vessel to the ambient environment. The means of connecting at least two mating electrical contacts to at least one anode electrode and at least one cathode electrode can further comprise at least one in-molded conductive element. At least two electrical contacts can make intimate connection between at least two mating electrical contacts when the removable attachable containment vessel is located within the cradle. The invention can be capable of intermittent batch processing as well as continuous processing in other embodiments. The containment vessel can be at least one of glass, plastic, metal, non-metal basket and/or a structure capable of enabling liquid mass exchange between the liquid within the interior of the containment vessel and an ambient liquid environment located outside the containment vessel.

The invention can further comprise at least one means to measure pH. At least one means to measure pH can produces at least one pH signal. At least one pH signal can be used as a means to provide feedback and/or to determinate when to terminate a reaction by switching current off and/or altering the flow of current between at least one electrode and at least one other electrode. The invention can further comprise the ability to control and/or alter the pH of a at least one liquid or a solution containing reactants. At least one liquid can be water from any source mixed with at least one additive and/or distilled water mixed with at least one additive and/or any combination thereof. At least one additive can contain at least one salt and/or at least one acid. At least one acid can be any weak acid of an organic salt including but not limited to at least one of acetic acid, citric acid, lactic acid, malic acid. At least one acid can be between 0.001% and 26% by weight in total solution concentration. At least one salt can be at least one chloride containing salt derived from the class of alkali metals or equivalents including but not limited to sodium chloride, lithium chloride, potassium chloride, cesium chloride, and rubidium chloride, pseudo alkali metals or equivalents including but not limited to ammonium chloride. At least one salt can be between 10 PPM and 20,000 PPM in total solution concentration. The additive can be a self-contained and/or premixed solution and added to a quantity of water from any source and/or distilled water. At least one additive can further comprise a water softener. The invention can further comprise an activated charcoal water filter and/or water filtration system. The invention can further comprise at least one source of UV light.

The source of power can produce a voltage. This voltage in combination with or without the transport of at least one liquid from at least one location can favor the production of hypochlorous acid. Hypochlorous acid can be produced at a concentration of approximately 200 parts per million. Hypochlorous acid can be produced at a concentration of less than 200 parts per million. Hypochlorous acid can be produced at a concentration of less than 300 parts per million. Hypochlorous acid can be produced at a concentration of less than 400 parts per million. Hypochlorous acid can be produced at a concentration of less than 500 parts per million. Hypochlorous acid can be produced at a concentration that is variable and determined by at least one set point.

The voltage, in combination with or without the transport of at least one liquid from at least one location can favor the production of sodium hydroxide. The voltage can produce both sodium hydroxide and hypochlorous acid. The source of power can be direct current. The source of power can be alternating current. At least one source of power can be an uncontrolled power source and/or a random AC and/or DC voltage waveform and/or a power source containing random AC and/or DC voltage waveform components. The direct current can be produced by at least one of at least one battery, fuel cell, solar cell, thermoelectric source, nuclear source, magnetic generator or generator that interacts with any source of mechanical energy. The direct current can be derived from the rectification of alternating current. The direct current can be half wave or full wave rectified alternating current. At least one source of power can use a transformer and/or power and/or voltage transformation system. The direct current can be transformed using a control circuit and/or electronics to produce a predominantly constant current. The direct current can result in the creation of variable current. At least one source of power can be a voltage between +10.5 volts and −10.5 volts.

At least one source of power can produce a current density in at least one anode electrode and at least one cathode electrode of less than 100 milliamps per square centimeter. At least one source of power can produce a current density in at least one anode electrode and at least one cathode electrode of less than 200 milliamps per square centimeter. At least one source of power can produce a current density in at least one anode electrode and at least one cathode electrode of less than 300 milliamps per square centimeter. At least one source of power can produce a current density in at least one anode electrode and at least one cathode electrode of less than 400 milliamps per square centimeter. At least one source of power can produce a current density in at least one anode electrode and at least one cathode electrode of less than 500 milliamps per square centimeter.

The control circuit and/or electronics can further comprise at least one current pass element. The control circuit and/or electronics can further comprise at least one means to measure current. At least one means to measure current can produce at least one current signal. At least one means to measure current can be at least one current sense resistor. At least one means to measure current can be at least one Hall Effect sensor. At least one means to measure current can use in whole or in part at least one coil. At least one means to measure current can measure at least one magnetic field and/or is influenced by at least one magnetic field.

At least one current signal can be used in whole or in part to produce an integrated quantity resulting in at least one value and/or at least one voltage, and at least one value and/or at least one voltage can be used in conjunction with at least one set point to produce at least one second signal, and at least one second signal can cause at least one current pass element to turn off and/or be altered and/or be modulated. The integrated quantity can be the result of analog integration, digital integration, or any combination thereof. At least one current pass element can be switched on and off and/or partially on and/or partially off or any combination thereof. At least one current pass element can be switched on and off and/or partially on and/or partially off or any combination thereof only as a function of at least one time period. At least one time period can be at least one variably settable time period. At least one variably settable time period can be at least one variably settable time period followed by at least one second variably settable time period where the current pass element can be switched off followed by at least one third variably settable time period where the current pass element can be switched on and off and/or partially on and/or partially off or any combination thereof.

The invention can further comprise at least one magnet. At least one magnet can be at least one of a permanent magnet, an electromagnet, a means of producing magnetism and/or the equivalent effect of magnetism. At least one current pass element can switch direct current and/or alternating current in such a manner as to produce at least one frequency. At least one frequency can be at least one variable frequency and/or at least one fixed frequency. At least one variable frequency can sweep for least one time from at least one minimum frequency to at least one maximum frequency over at least one period of time and from at least one maximum frequency to at least one minimum frequency over at least one second period of time and at least one period of time may or may not be equal to at least one second period of time. At least one variable frequency can be at least one variable frequency and/or at least one fixed frequency determined by at least one algorithm. At least one algorithm can use as at least one input at least one current sensed and/or the maximization of at least one current sensed by at least one current sensing system. At least one algorithm can hunt and seek at least one mechanical resonance frequency of at least one assembly containing at least one anode electrode and/or at least one cathode electrode. At least one variable frequency can causes at least one anode electrode and/or at least one cathode electrode to mechanically vibrate.

At least one anode electrode can be constructed from at least one first conductive material. At least one first conductive material can comprise at least one coating. At least one coating can act as a catalyst. At least one cathode electrode can be constructed from at least one second conductive material. At least one second conductive material can comprise at least one second coating. At least one second coating can act as a catalyst. At least one anode electrode and at least one cathode electrode can both be constructed from the same at least one conductive material and/or at least one conductive material coated with at least one coating. At least one anode electrode and/or at least one cathode electrode can comprise in whole or in part a conductive screen and/or perforated conductive material. At least one anode electrode can be printed upon at least one first substrate and/or at least one cathode electrode can be printed upon at least one first substrate and/or at least one second substrate. At least one anode electrode can be thermoformed and/or in-molded within at least one first substrate and/or at least one cathode electrode can be thermoformed and/or in-molded within at least one first substrate and/or at least one second substrate. In-molding in the context of this application is a process by which a conductive element is molded within an element that can be plastic or another thermo-formable material, and this can employ injection molding, thermoforming, casting, and/or blow molding. While it is anticipated that in-mold technology can be used, it is not required to remain within the spirit of the invention, and any method deemed practical may be employed. At least one anode electrode and at least one cathode electrode can be assembled in a cylindrical arrangement. At least one anode electrode and at least one cathode electrode can be curved. At least one anode electrode and at least one cathode electrode can be at least one of planar, at least one layer of alternating electrodes stacked, and/or at least one pair of electrodes separated by at least one insulating material. At least one anode electrode and at least one cathode electrode can be used as a sensor and/or sensing element.

The containment vessel can further comprise a pressure release valve and/or a means to release pressure.

The invention can further comprise the ability to change the product ratios and/or product composition of a chemical reaction by controlling at least one of voltage, current, power, time of applied voltage and/or current, and/or removal of at least one liquid from at least one location. At least one means to cause the transport of at least one liquid from the containment vessel to the ambient can be at least one pump. At least one pump can be at least one of manually operated, electronically operated, hydraulically operated, pneumatically operated, ionicly operated, piston operated, positive displacement, peristaltic, turbine operated, impeller operated, and/or any combination. At least one liquid can be delivered to the ambient in the form of an atomized mist and/or at least one liquid stream and/or any combination of at least one liquid stream and an atomized mist.

The invention can further comprise of an agitation system comprising a motor in the base unit, a magnet affixed to the motor shaft via a coupling, a motor control circuit, a paddle assembly containing a complementary second magnet and/or magnetic metal capable of being influenced and spun by a magnet, and the paddle assembly can be located within the removable attachable containment vessel. The motor control circuit can cause power to be applied to the motor in at least one of the following patterns: continuously powered, intermittently powered, powered at at least one variable speed, powered at at least one constant speed, powered in either directional sense of motor shaft rotation, and/or any combination thereof. These patterns can occur during the time when a chemical reaction is actively being induced through the passage of current between at least one anode electrode and at least one cathode electrode.

The invention can further comprise the ability to actuate automatically as a function of monitored conditions including but not limited to electronic trigger, wireless trigger, prophylactic application, trigger based on the sensing of plant(s) and/or material of plant origin, animal(s) and/or material of animal origin, insects, bedbugs, arthropods, arachnids, eggs, larvae, bacteria, viruses, protista, prions, rickettsia, single cell organisms, multi-cellular organisms, contaminants, waste material, sebaceous bodily secretions and/or effluence, fecal matter, skin, blood, cytoplasm, protoplasm, plasma, urine, vomit, semen, urinary tract discharge, vaginal discharge, oral discharge, ocular discharge, nasal discharge, ear discharge, biological material of any origin, chemicals, pH, dust, spores, mold, fungus, yeast, anaerobes, aerobes.

The invention can be used in sanitizing applications on surfaces and volumes located within systems and venues including but not limited to restaurants, cleaning tables, swimming pools, aquariums, military applications, third world applications, areas of infectious disease outbreaks, door handles, knobs, airplanes, cruise ships, trains and rail cars, busses, taxis, cars, hotels, hospitals, infirmaries, field hospitals, first aid stations, schools, airports, bus terminals, train stations, pipelines, public rest rooms, home exterior cleaning, industrial exterior cleaning, home filtration systems, refrigerators and/or refrigeration systems, misters, dishwashers, ice machines, HVAC systems, humidifiers, dehumidifiers, environmental control systems, locker rooms, public showers, prisons, detention centers, interrogation rooms, play pens, ball pens, day care centers, playgrounds, play items and structures found in playgrounds, gymnasiums, gymnastic equipment and/or machinery, exercise equipment and/or machinery, churches, nursing homes, assisted living facilities, funeral homes, morgues, police stations, nail salons, manicure and pedicure salons, beauty parlors, cosmetics counters, sales counters, delicatessens and/or locations where food is dispensed over the counter, agricultural applications, green houses, hydroponics systems, water treatment facilities, gray water transport systems, systems using recycled water, fracking operations, waste treatment facilities, food processing plants, food processing machinery including but not limited to extruders, dryers, mixers, rollers, cookers, die washers, food handlers, hoppers, conveyers, shakers and vibratory conveyors, grain storage silos, food packaging machinery, vegetable spraying, slaughter houses, meat spraying, robotic cleaning systems, autonomous robotic applications, floral industry, water parks, treatment systems for acne, eczema, psoriasis, dermatitis.

Embodiments of the invention can further comprise at least one of an audio alert, a signal, a visual alert and/or indicator comprising at least one of LED, strobe, incandescent, florescent, electroluminescent.

The invention can further comprise at least one means of communication. At least one means of communication can be at least one of RFID, near field NFC device, unpowered NFC chip tags, Bluetooth in 2400-2480 mhz band, Bluetooth in bands now known or unknown, frequency hopping spread spectrum based systems, Wifi, Zigbee IEEE 802.15 standard, communication for use in industrial, scientific, and medical bands utilizing 686 MHZ in Europe and/or 915 MHZ in the US and/or 2.4 GHZ in most worldwide jurisdictions, radio, cell phone, optical, acoustic.

In another embodiment the invention can further comprise of at least one partial zone isolation and/or at least one mechanical baffle. At least one second means to cause the transport of at least one liquid from at least one location is at least one of at least one pump, at least one gravity siphon, and/or at least one method employing capillary action. The pump can remove at least one liquid from at least one location from within the removable attachable containment vessel. At least one pump can operate intermittently for at least one period of time. The invention can further comprise a removable wick placed in the liquid in at least one location within the removable attachable containment vessel.

Another embodiment of the invention can include a means to micro-encapsulate at least one liquid, and this can take the form of an enclosure of volume that separates the interior from the ambient, and this can enable the transport of at least one liquid to another location where it can then be used.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF DRAWINGS

FIG. 1 depicts one embodiment of the invention showing the product production system, the base unit, the containment vessel, and the solution refill

FIG. 2 depicts the same embodiment of the invention showing the product production system, the base unit, the containment vessel, and the electrode assembly

FIG. 3 depicts one embodiment of a more detailed embodiment of the electrode assembly.

FIG. 4A depicts a schematic representation of the electrodes and feed wires.

FIG. 4B depicts a cross sectional view of the schematic representation.

FIGS. 5A-5E depict several embodiments of the invention, including anticipated features.

FIG. 6 depicts an embodiment of the invention for an industrial application.

FIG. 7A shows an embodiment of the invention that can shake the bubbles from an electrode.

FIG. 7B shows a typical electrode in a vessel in which electrolysis is occurring.

FIG. 8A shows a representative graph of frequency vs. time for a voltage applied to the electrodes during the search for a mechanically resonant frequency in one embodiment of the invention.

FIG. 8B shows a representative graph of frequency vs. time for a voltage applied to the electrodes during normal operation in one embodiment of the invention.

FIG. 8C shows a representative graph of voltage vs. time for a voltage applied to the electrodes during normal operation in one embodiment of the invention.

FIG. 9 shows a schematic embodiment of the invention employing an electrode segregation baffle to partially isolate the liquid region around the electrodes for selective siphoning off of unwanted product to favor production of a desired product.

### DETAILED DESCRIPTIONS OF DRAWINGS

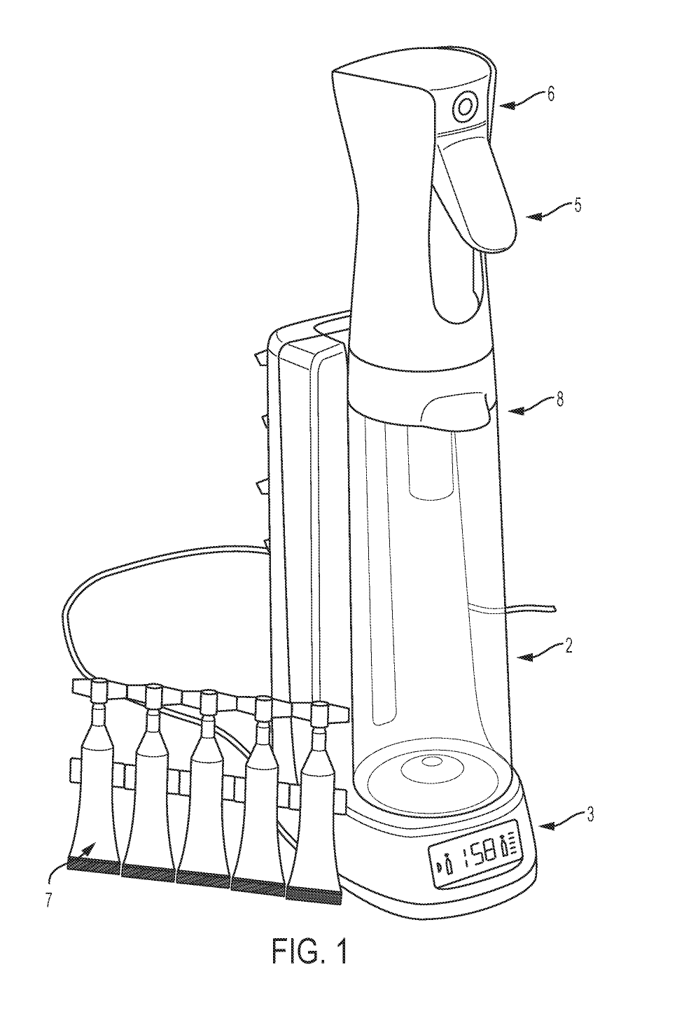

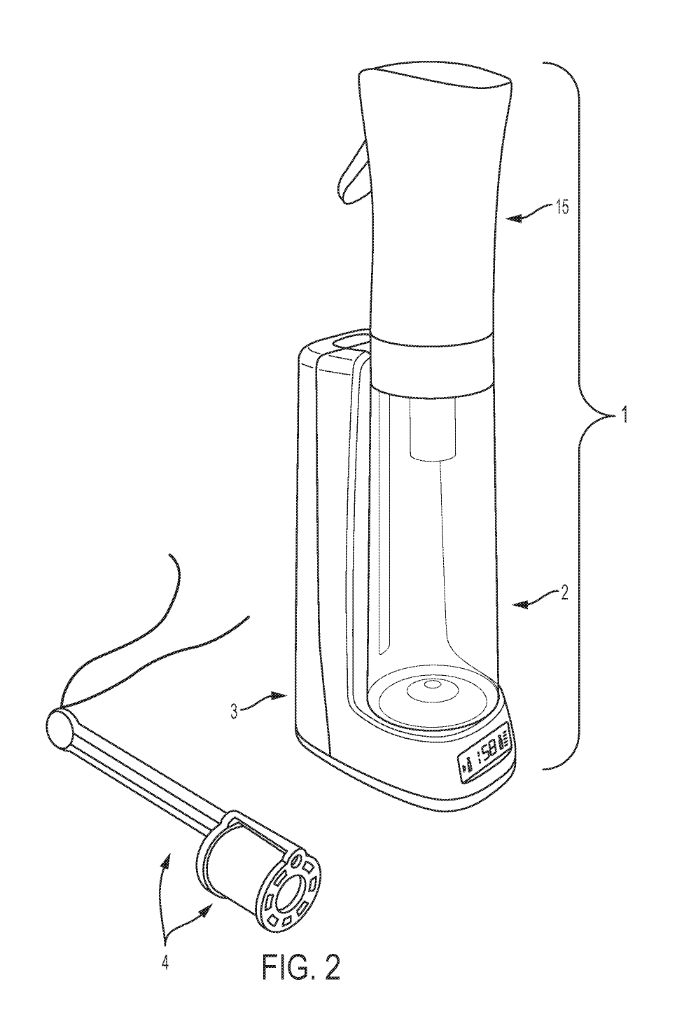

FIG. 1 and FIG. 2 depict one embodiment of the invention showing the product production system 1, the base unit 3, the containment vessel 2, head unit 15, and more than one solution refill package 7. Also shown is a beak 8 that houses the location where the electrical contacts are made to feed power to the electrode assembly 4. When the pump 5 is manually actuated, solution sprays from the spray nozzle 6. A solution refill package 7 can contain a salt such as common table salt and an acid such as vinegar for the adjustment of solution pH, though the refill package contents is not limited to table salt or vinegar.

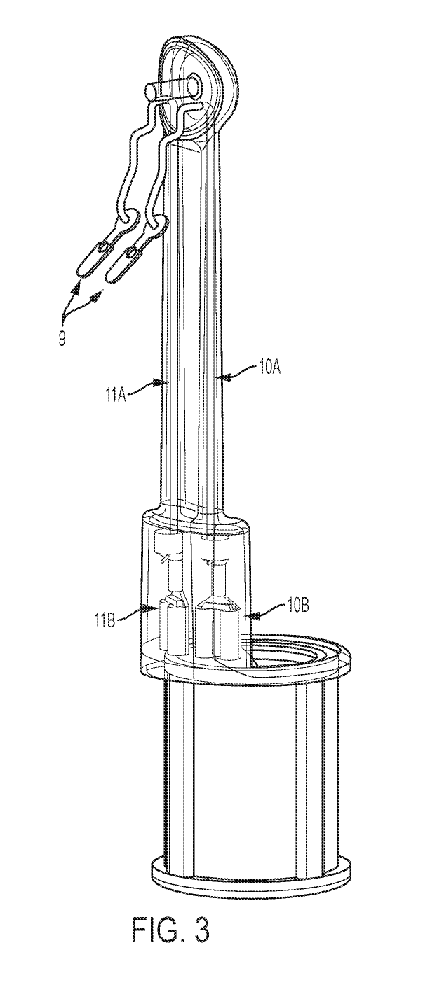

FIG. 3 depicts one embodiment of a more detailed embodiment of the electrode assembly 4.

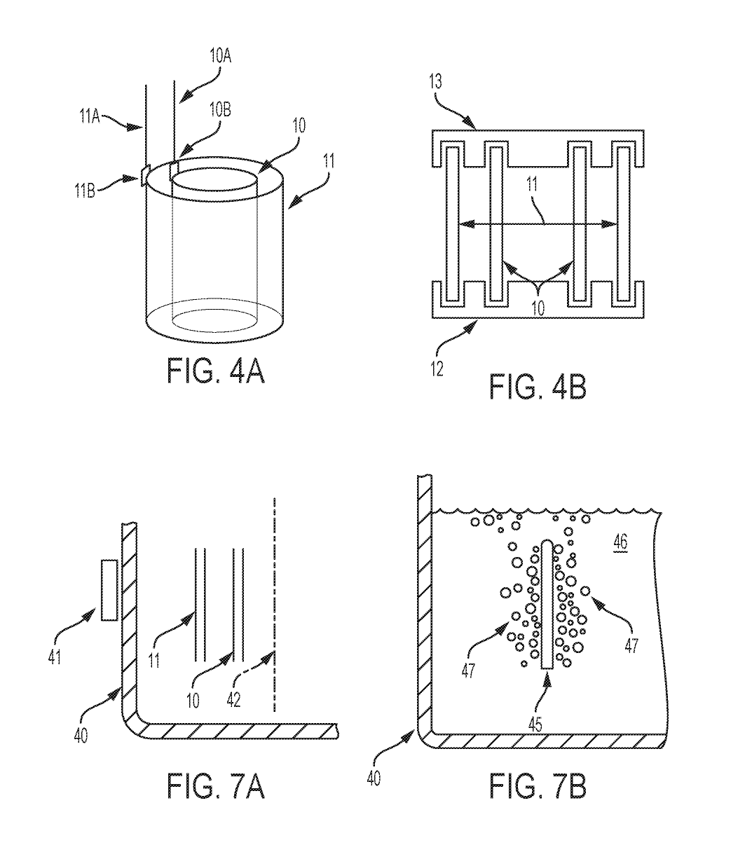

FIG. 4A depicts a schematic representation of the anode 10, anode feed wire 10A, anode attachment spade 10B, cathode 11, cathode feed wire 11A, and cathode attachment spade 11B.

FIG. 4B depicts a cross sectional view of the schematic representation showing the anode 10, cathode 11, top electrode support spacer 13 and bottom electrode support spacer 12. FIG. 3 also shows the contact pads 9 which are located under the beak 8 shown in FIG. 1.

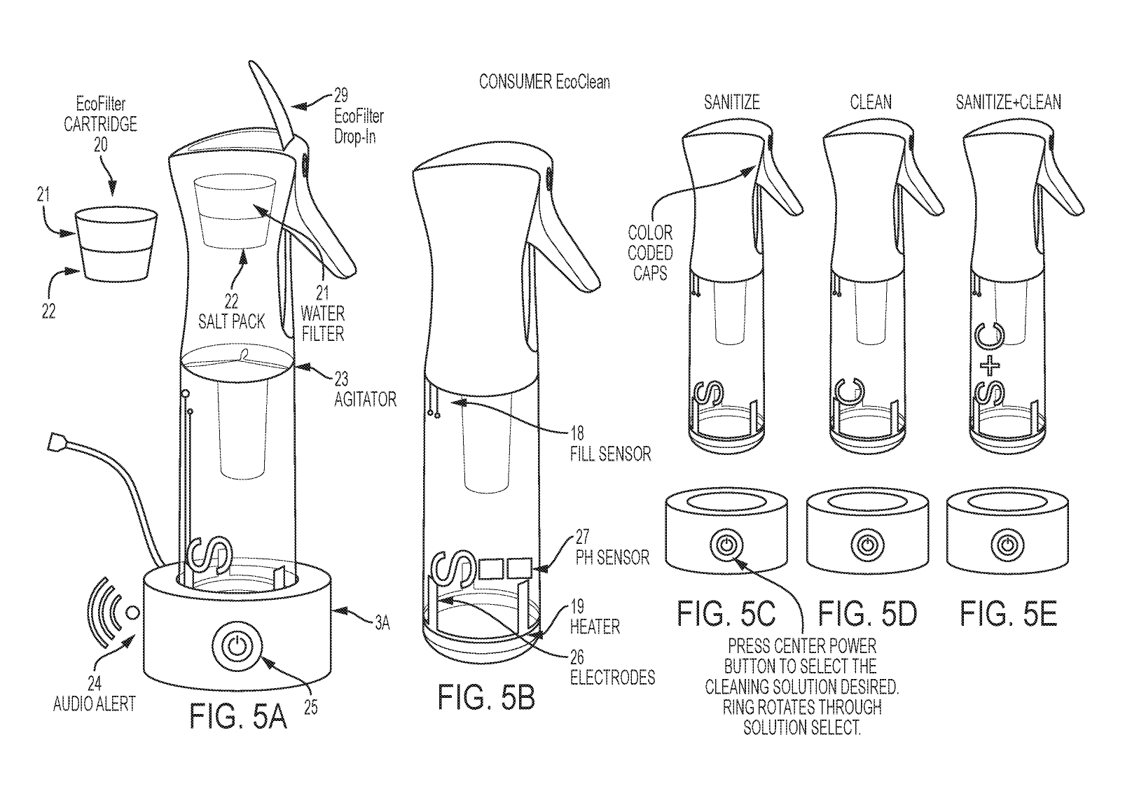

FIGS. 5A-5E depict several embodiments of the invention, including anticipated features. FIG. 5A depicts an embodiment including an eco filter cartridge 20, which can consist of both a water filter 21 and a salt pack 22, though is not limited to these components. The cover 29 is opened to enable the eco filter cartridge 20 to be inserted into the head unit 15. Shown is an agitator 23 located within the containment vessel 2, and can be located on the top as shown or on the bottom of the containment vessel. In another embodiment the base unit 3A can also contain a magnetic stirring system to spin the agitator 23. Also shown is an audio alert 24 which can signal when the reaction products are at the proper concentration and the cleaning and/or sanitizing solution is ready for use. FIG. 5B contains electrodes 26, a heater 19, a pH sensor 27, and a fill sensor 18. FIG. 5C shows an embodiment of the invention where the reaction products produced are for a sanitizing application. FIG. 5D shows an embodiment of the invention where the reaction products produced are for a cleaning application. FIG. 5E shows an embodiment of the invention where the reaction products produced are for a sanitizing and cleaning application.

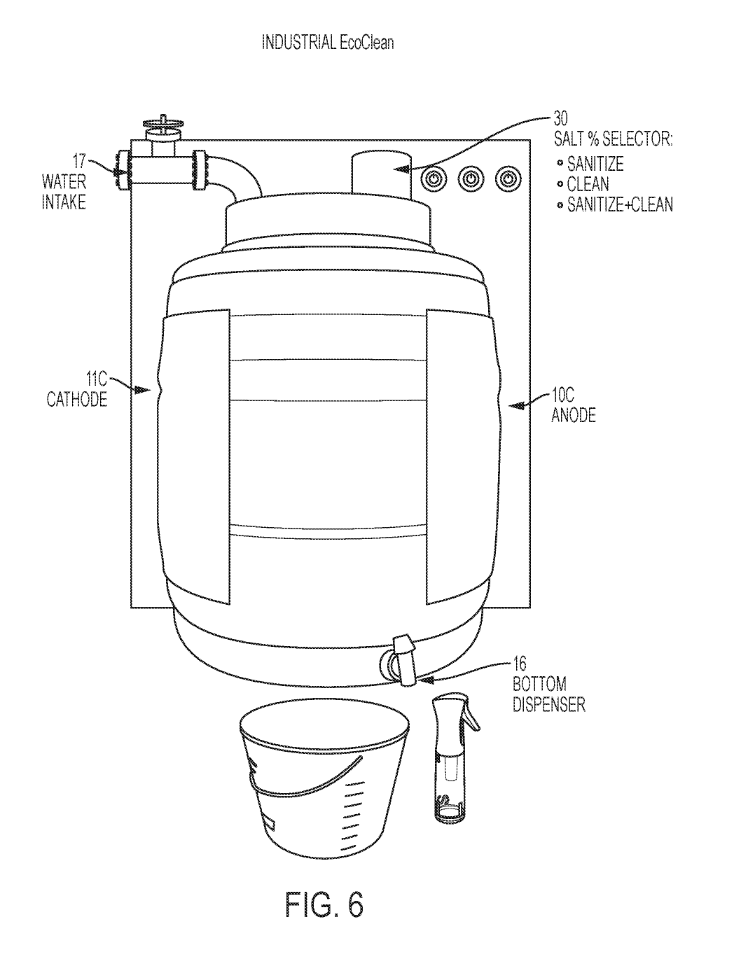

FIG. 6 depicts an embodiment of the invention for an industrial application. Shown is the anode 10C, cathode 11C, water intake 17, and the bottom dispenser 16. The salt percent selector 30 can select whether the reaction products favor a sanitizing solution, a cleaning solution, or both a sanitizing and cleaning solution.

FIG. 7B shows a typical electrode 45 in a vessel with vessel wall 40, in which electrolysis is occurring within solution 46. As gas bubbles 47 are being produced, the area of a typical electrode 45 in contact with solution 46 is reduced, and this increases the contact impedance between a typical electrode 45 and the solution 46.

FIG. 7A shows an embodiment of the invention wherein the current passing through a typical electrode 45 can cause an interaction with magnet 41 and shake the bubbles from a the typical electrode 45. Shown in cross section is the vessel wall 40, the magnet 41, cathode 11, anode 10, and the electrode center line 32.

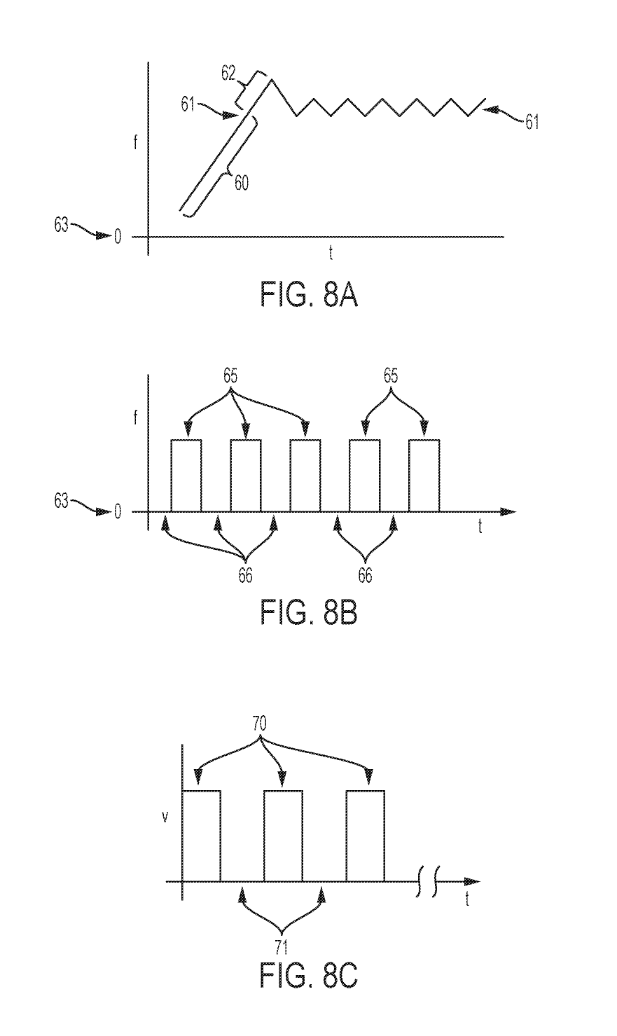

FIG. 8A shows a representative graph of frequency vs. time for a voltage applied to the electrodes during the search for a mechanically resonant frequency in one embodiment of the invention. In this mode of operation, a changing frequency would be applied, in this case an increasing frequency, until resonance is detected. Shown is when only a DC voltage 63 is applied. Also shown is the frequency region below mechanical resonance 60, frequency of mechanical resonance 61, and the frequency region above mechanical resonance 62.

FIG. 8B shows a representative graph of frequency vs. time for a voltage applied to the electrodes during normal operation in one embodiment of the invention. In this graph periods of time when DC is applied 66 are separated by periods when a frequency is applied 66. In this scenario, when DC voltage 63 is applied, gas bubbles 47 are produced at the interface between a typical electrode 45 and the solution 46, and this reduces the area of contact between the typical electrode 45 and the solution 46. By periodically driving the entire electrode assembly 4 into mechanical resonance, it is possible to shake many of the gas bubbles 47 from the typical electrode 45. This can be sense by detecting the maximization of current being passed through the electrode-solution system, and current sensing can be done in any number of ways and should not be limited to any one specific way without departing from the spirit of the invention. DC voltage 63 can then be applied until the current reduces either by a threshold percentage or to a certain preset or variable value, and then the electrode assembly 4 can one again be shaken by application of a frequency of mechanical resonance 61. Due to the variable nature of the system, the frequency of mechanical resonance 61 is taken to mean a range of frequencies on or about the mechanically resonant frequency, and in practice this can be an oscillating or modulated frequency that can effectively cause gas bubbles 47 to be released. The strategy is to maximize the total current-time product per unit time so as to minimize the total time necessary to affect the chemical change desired in the solution 46.

FIG. 8C shows a representative graph of voltage vs. time for a voltage 70 applied to the electrodes for a period of time followed by a voltage off period 71 for a different period of time during operation in one embodiment of the invention. In this mode of operation, gas bubbles 47 are produced during the period when voltage 70 is applied, then gas bubbles 47 are given time to diffuse into solution 46 during the voltage off period 71. The voltage off period 71 can either be fixed or variable, and the impedance between the anode 10 and cathode 11 can be determined by application of a short voltage burst just long enough to enable a current measurement, and this impedance can be used to determine when next to apply voltage 70.

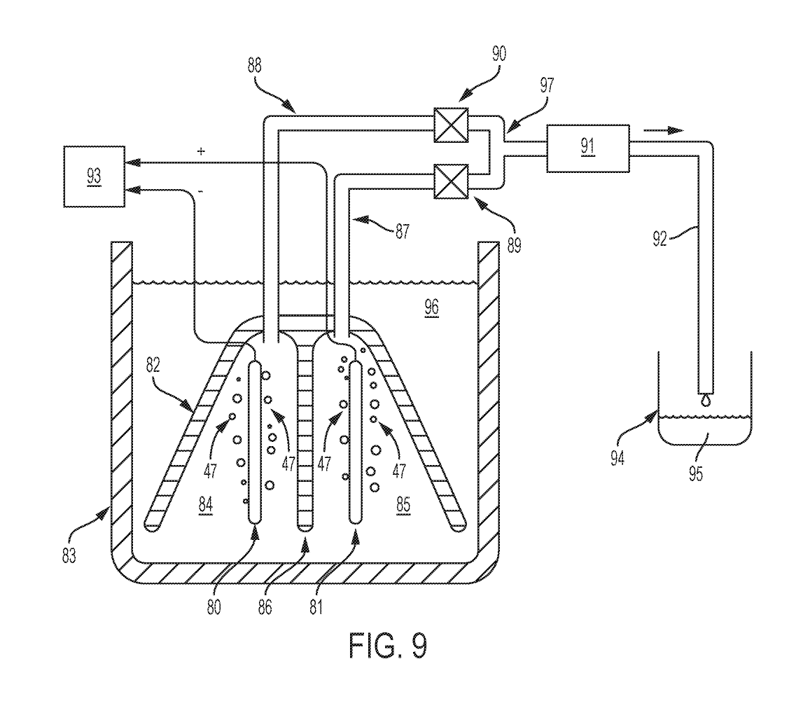

FIG. 9 depicts an embodiment of the invention that enables production of either sodium hydroxide at the cathode 80 or hypochlorous acid at the anode 81. The anode 81 and liquid region around the anode 85 is segregated from the cathode 80 and the liquid region around the cathode 84 by the baffle 82. The baffle 82 does not completely isolate the electrode region as in other more complicated designs that rely on semi-permeable membranes that completely isolate each respective electrode. As current flows from the power source 93 into the anode 81 and cathode 80, the current path is completed in the region free for fluid mixing and ion exchange 86. There can even be holes (not shown) that allow ion transport and current flow through the partition separating the anode 81 and liquid region around the anode 85 and the cathode 80 and the liquid region around the cathode 84. If, for instance, it were desired to produce a solution rich in sodium hydroxide, the anode flow valve 89 would be opened and the cathode flow valve 90 would be closed. When pump 91 is energized, which can either be continuously operated or periodically pulsed, liquid rich in hypochlorous acid would be drawn off from the liquid region around the anode 87 which would thus enter the mixing T 97 and exit the output tube from pump 92 and be deposited in waste vessel 94 as waste solution rich in product not wanted 95. This would leave a higher concentration of sodium hydroxide in the liquid solution rich in desired product 96. If on the other hand, it were desired to produce a solution rich in hypochlorous acid, the cathode flow valve 90 would be opened and the anode flow valve 89 would be closed. When pump 91 is energized, which can either be continuously operated or periodically pulsed, liquid rich in sodium hydroxide would be drawn off from the liquid region around the cathode 84 which would thus enter the mixing T 97 and exit the output tube from pump 92 and be deposited in waste vessel 94 as waste solution rich in product not wanted 95. This would leave a higher concentration of hypochlorous acid in the liquid solution rich in desired product 96.

1. A product production system comprising:
a base unit comprising of:
a source of power;
a control circuit and/or electronics;
a means of connecting said source of power to at least two electrical contacts;
a cradle;
a removable attachable containment vessel comprising of:
at least one liquid that can be added and/or removed;
at least one anode electrode;
at least one cathode electrode;
a means of connecting at least two mating electrical contacts to said at least one anode electrode and said at least one cathode electrode;
at least one means to cause the transport of said at least one liquid from said containment vessel to the ambient.

2. The product production system of claim 1 wherein said means of connecting at least two mating electrical contacts to said at least one anode electrode and said at least one cathode electrode further comprises at least one in-molded conductive element.

3. The product production system of claim 1 wherein said at least two electrical contacts make intimate connection between said at least two mating electrical contacts when said removable attachable containment vessel is located within said cradle.

4. The product production system of claim 1 is capable of intermittent batch processing.

5. The product production system of claim 1 is capable of continuous processing.

6. The product production system of claim 1 wherein said containment vessel is at least one of glass, plastic, metal, non-metal basket and/or a structure capable of enabling liquid mass exchange between said liquid within the interior of said containment vessel and an ambient liquid environment located outside said containment vessel.

7. The product production system of claim 1 further comprising at least one means to measure pH.

8. The product production system of claim 7 wherein said at least one means to measure pH produces at least one pH signal.

9. The product production system of claim 8 wherein said at least one pH signal is used as a means to provide feedback and/or to determinate when to terminate a reaction by switching current off and/or altering the flow of current between at least one electrode and at least one other electrode.

10. The product production system of claim 1 further comprising the ability to control and/or alter the pH of said liquid or a solution containing reactants.

11. The product production system of claim 1 wherein said at least one liquid is water from any source mixed with at least one additive and/or distilled water mixed with said at least one additive and/or any combination thereof.

12. The product production system of claim 11 wherein said at least one additive contains at least one salt and/or at least one acid.

13. The product production system of claim 12 wherein said at least one acid is any weak acid of an organic salt including but not limited to at least one of acetic acid, citric acid, lactic acid, malic acid.

14. The product production system of claim 12 wherein said at least one acid is between 0.001% and 26% by weight in total solution concentration.

15. The product production system of claim 12 wherein said at least one salt is at least one chloride containing salt derived from the class of alkali metals or equivalents including but not limited to sodium chloride, lithium chloride, potassium chloride, cesium chloride, and rubidium chloride, pseudo alkali metals or equivalents including but not limited to ammonium chloride.

16. The product production system of claim 12 wherein said at least one salt is between 10 PPM and 20,000 PPM in total solution concentration.

17. The product production system of claim 11 wherein said at least one additive is a self-contained and/or premixed solution and added to a quantity of said water from any source and/or distilled water.

18. The product production system of claim 11 wherein said at least one additive further comprises a water softener.

19. The product production system of claim 1 further comprising of an activated charcoal water filter and/or water filtration system.

20. The product production system of claim 1 further comprising of at least one source of UV light.

21-100. (canceled)
